(19) United States
(12) Patent Application Publication
(10) Pub. No.: US 2017/0205990 A1
(43) Pub. Date: Jul. 20, 2017

(54) METHOD, SYSTEM, AND APPARATUS FOR CONTROLLING DISPLAY REGIONS FOR AN ELECTRONIC DEVICE

(71) Applicant: Lenovo (Beijing) Limited, Beijing (CN)

(72) Inventor: Wenchao Ma, Beijing (CN)

(21) Appl. No.: 15/408,184

(22) Filed: Jan. 17, 2017

(30) Foreign Application Priority Data
Jan. 14, 2016 (CN) 201610180335.5

(51) Int. Cl. G06F 3/0481; G06F 3/0484; G06F 3/0488

(52) U.S. Cl. CPC G06F 3/04817; G06F 3/04883; G06F 3/04845; G06F 3/04886

(57) ABSTRACT

A method for controlling display regions for applications of an electronic device, where the method includes detecting, on a display of an electronic device configured to display a first application interface corresponding to a first application and a shortcut interface comprising one or more second application icons, a first operation performed on one of the one or more second application icons. The method further includes determining whether the first operation satisfies a predetermined condition, and defining a first display region and a second display region in response to determining that the first operation satisfies the predetermined condition. A system and an apparatus are also capable of performing various embodiments of the method.

### FIELD

The present application relates to the field of electronic technologies, and in particular, relates to an information processing method and an electronic device.

### BACKGROUND

Electronic devices such as mobile phones, personal computers, tablet personal computers and the like, enable a user to use various applications.

### SUMMARY

A method for controlling display regions for application on an electronic device is disclosed. In one embodiment, the method includes detecting, on a display of an electronic device configured to display a first application interface corresponding to a first application and a shortcut interface comprising one or more second application icons, a first operation performed on one of the one or more second application icons. The method further includes determining whether the first operation satisfies a predetermined condition, and defining a first display region and a second display region in response to determining that the first operation satisfies the predetermined condition.

A system is disclosed that, in one embodiment, includes a display, a processor that is configured to display a first application interface corresponding to a first application and a shortcut interface comprising one or more second application icons, and a memory storing code that is executable by the processor to perform detecting, on the display, a first operation performed on one of the one or more second application icons.

In the embodiment, the code is further configured to perform determining whether the first operation is one of a first predetermined operation selected from the group consisting of taps, swipes, presses, and combinations thereof, and a second predetermined operation selected from the group consisting of taps, swipes, presses, and combinations thereof. In the embodiment, the code is further configured to perform defining a first display region and a second display region based on the first operation.

An apparatus is disclosed that in one embodiment includes a control module configured to control a display of an electronic device to display a first application interface corresponding to a first application and a second interface comprising one or more second application icons. The electronic device further includes a detection module configured to detect and acquire a first operation performed for one of the one or more the second application icons.

The apparatus further includes, in one embodiment, a determination module configured to determine whether the first operation satisfies a first predetermined condition, and when the first operation satisfies the first predetermined condition, determine, from the display, a first display region and a second display region that does not overlap the first display region and a display module configured to display, in the second display region, a second application interface of a second application corresponding to the second application icon, and display, in the first display region, an interface related to the first application interface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic flow chart diagram illustrating one embodiment of a method of controlling display regions of an electronic device;

FIG. 1B is a schematic flow chart diagram illustrating another embodiment of a method of controlling display regions of an electronic device;

FIG. 1C is a schematic flow chart diagram illustrating an overview of various steps depicted in other figures, of a method of controlling display regions of an electronic device;

FIG. 2A is a schematic block diagram illustrating a display screen of an electronic device displaying a first display region and a second display region that does not overlap the first display region;

FIG. 2B is a schematic block diagram illustrating a display screen of an electronic device displaying a first display region that includes the entire display screen of the electronic device and a second display region that overlaps the first display region;

FIG. 3 is a schematic flow chart diagram illustrating additional steps that may be performed by the method in some embodiments;

FIG. 4 is a schematic block diagram illustrating an operation for switching an electronic device from displaying a single first application interface to simultaneously displaying the first application interface and a shortcut operation interface (also referred to as a “shortcut interface”) on the display screen of an electronic device;

FIG. 5 is a schematic flow chart diagram of steps for determining which application icons are to be displayed in the shortcut interface in some embodiments;

FIG. 6 is a schematic flow chart diagram of a one embodiment of steps for displaying in a second display region an application interface of a second application corresponding to a second application icon;

FIG. 7 is a schematic block diagram illustrating one embodiment of determining a resized first display region and a resized second display region;

FIG. 8 is a schematic block diagram of determining the position of a line between a resized first display region and a resized second display region based on an ending point of an operation performed on one of the one or more second application icons;

FIG. 9 is a flow diagram of steps for displaying a second application corresponding to a second application icon in the first display region and controlling the first application to be in a non-display state;

FIG. 10 is a schematic block diagram of one embodiment of an apparatus for controlling display regions of an electronic device using the methods described; and

FIG. 11 is a schematic block diagram of one embodiment of an apparatus for controlling display regions of an electronic device.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. In some embodiments, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, and alternate embodiments of like elements are referred to with similar numbering.

Embodiments described herein provide an electronic device with methods to solve a technical problem identified by the inventors in existing electronic devices in which, in some electronic devices during the application switching process, the application interface has a single display effect.

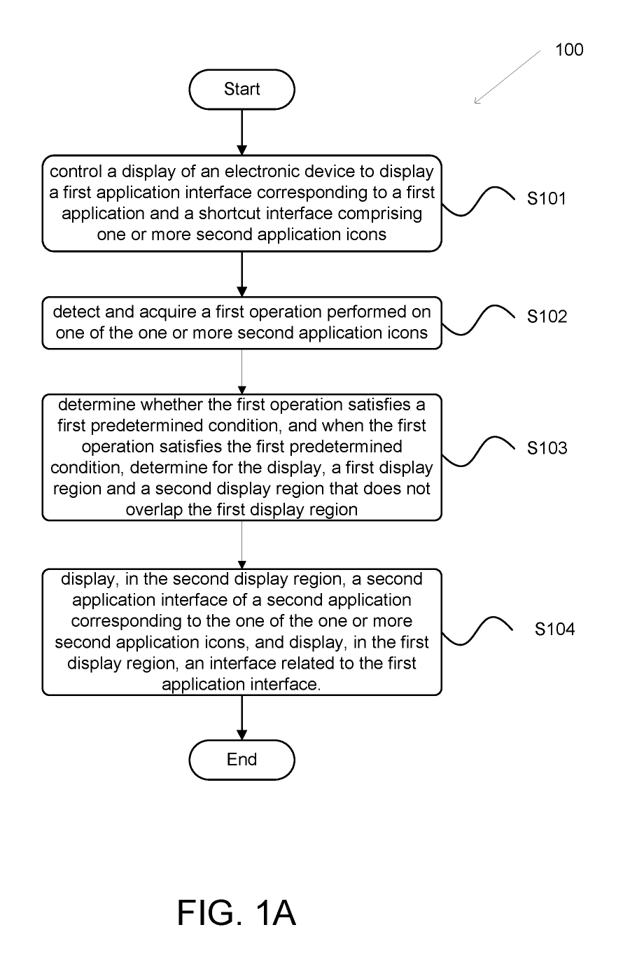

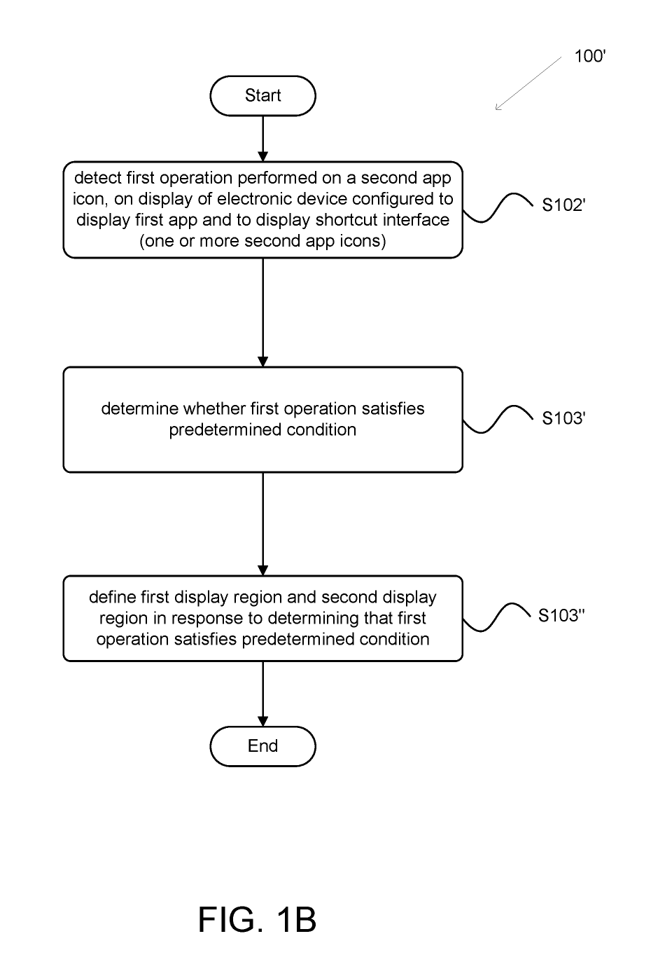

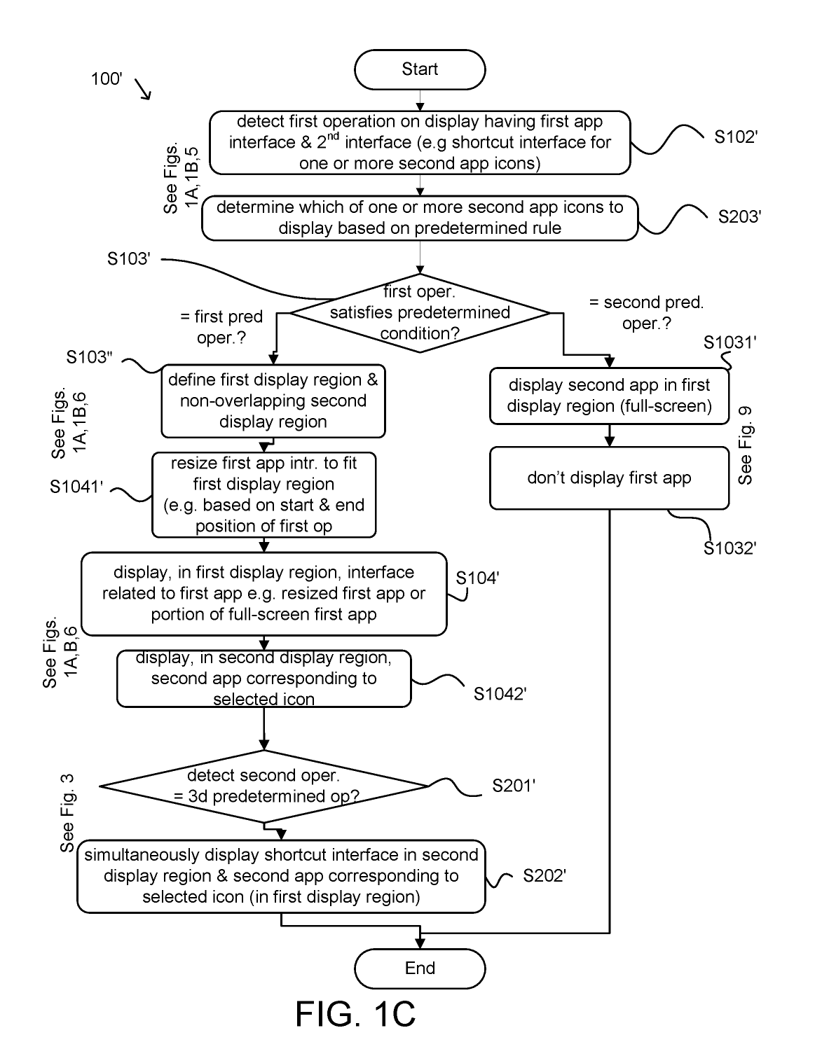

FIG. 1A is a schematic flow chart diagram illustrating one embodiment of a method 100 of controlling display regions of an electronic device. In the embodiment, the method 100 includes S101 controlling a display of an electronic device to display a first interface for a first application and a second interface, also referred to as a shortcut interface for one or more second application icons with each icon corresponding to one of one or more second applications. In some embodiments, the shortcut operation interface is displayed in a region close to the edge of the display screen or displayed in the edge region of the display screen facilitating a user's operations with the user's fingers. The method 100 further includes S102 detecting and acquiring a first operation performed on one of the one or more second application icons.

In some embodiments, reference to detecting an operation may be understood to refer to detecting and acquiring the operation. The method 100 further includes determining S103 whether the first operation satisfies a first predetermined condition, and when the first operation satisfies the first predetermined condition, determining for the display, a first display region and a second display region that does not overlap the first display region. The method 100 further includes displaying S104 the second interface in the second display region, and displaying an interface related to the first application interface in the first display region.

In some embodiments of the method 100, an interface of a currently running first application displays a shortcut interface; a second application switching operation is performed for a second application icon in the shortcut interface; and when the operation satisfies a predetermined condition, a first display region for displaying the first application interface and a second display region for displaying the second application interface corresponding to the second application icon may be defined for the display interface.

This is a significant improvement over existing electronic devices in which an interface for a second application may be only displayed in full screen when the second application switching operation is performed for the second application icon in the shortcut display interface. Therefore, the technical problem in the related art that when the electronic device is in the application switching process, the application interface has a single display effect is effectively solved.

FIG. 1B is a schematic flow chart diagram illustrating one embodiment of a method 100′ of controlling display regions of an electronic device. The steps of method 100′ are substantially similar to similarly numbered steps of method 100 described above with respect to FIG. 1A and descriptions provided herein may be applied accordingly.

In the embodiment, the method 100′ includes detecting S102′, on a display of an electronic device configured to display a first application interface corresponding to a first application and a shortcut interface comprising one or more second application icons, a first operation performed on one of the one or more second application icons. The method 100′ further includes determining S103′ whether the first operation satisfies a predetermined condition. The method 100′ further includes defining a first display region and a second display region in response to determining that the first operation satisfies the predetermined condition.

In some embodiments of the method 100′ the electronic device may be a mobile phone, a laptop personal computer, an iPad and the like, or may be any other electronic device having a display. It may be understood by one of skill in the art that references to a display refer to a touchscreen display or similar display that is capable of detecting operations such as taps, swipes, presses and the like, for example by a user's finger, a stylus, and the like.

For example, in some embodiments, some examples where the electronic device is a mobile phone are described below. However other electronic devices have been a display screen may embody the methods and apparatuses described below with respect to the mobile phone examples.

In some embodiments of the method 100′, step S102′ is performed first, that is, detecting an operation performed on a second application icon on an electronic device that is configured to display a first application interface corresponding to a first application and a second interface, also referred to as a shortcut interface comprising one or more second application icons.

In some embodiments, for example, the operating system of the mobile phone may be the Android operating system, the iOS operating system. The Windows operating system, or another operating system. In the embodiments, regardless of the operating system used in the mobile phone, various applications may be installed in the mobile phone. In some embodiments, the installed applications may include for example, gaming applications and music applications in the entertainment category, the QQ application and WeChat application in the communication category, and finance management applications and shopping applications in the life and service category.

In some embodiments, using the mobile phone with the Android operating system installed as an example, the mobile phone may include applications in the entertainment category, the communication category, the office category and the like categories via an application platform provided by the Android operating system. For purposes of illustration, assume that the applications installed in the mobile phone include a first application in the entertainment category, and a second and third applications in the communication category.

In some embodiments, the method 100′ further includes determining S103′ whether the first operation satisfies a predetermined condition. For example, various predetermined conditions may include determining whether a first operation is a first predetermined operation, a second predetermined operation, a third predetermined operation and so forth. Each predetermined operation may be a compound operation that includes a number of taps, swipes, and/or presses performed by a user. Different predetermined operations may include different actions performed in different orders.

In one embodiment, the method 100′ further includes defining S103′ a first display region and a second display region in response to determining that the first operation satisfies the predetermined condition. As illustrated in the example, a user may operate any one of the three applications installed in the mobile phone, and the mobile phone may respond to the operation and display a corresponding interface of the application on the display screen of the mobile phone.

In an example embodiment in which the applications in the mobile phone include a first application, a second application and a third application, the mobile phone may define a region of the display screen of the mobile phone to display an interface of any one of the above three applications in the mobile phone. The mobile phone may also define another region of the display screen of the mobile phone to display a shortcut operation interface comprising one or more application icons, each icon corresponding to one of the other applications.

For ease of description, the above two regions are referred to as a first region and a second region respectively. In this embodiment, the mobile phone may control the display screen of the mobile phone to display the first application interface in the first region and display, in the second region, a shortcut operation interface that includes a second application icon corresponding to the second application and also includes a third application icon corresponding to the third application.

In some embodiments, the mobile phone may control the display screen of the mobile phone to display a second application interface in the first region, and display a shortcut operation interface that includes a first application icon corresponding to the first application, the second application icon corresponding to the second application, and the third application icon corresponding to the third application. In still other embodiments, the mobile phone may further control the display screen of the mobile phone to display a third application interface in the first region, and display a shortcut operation interface comprising the first application icon corresponding to the first application.

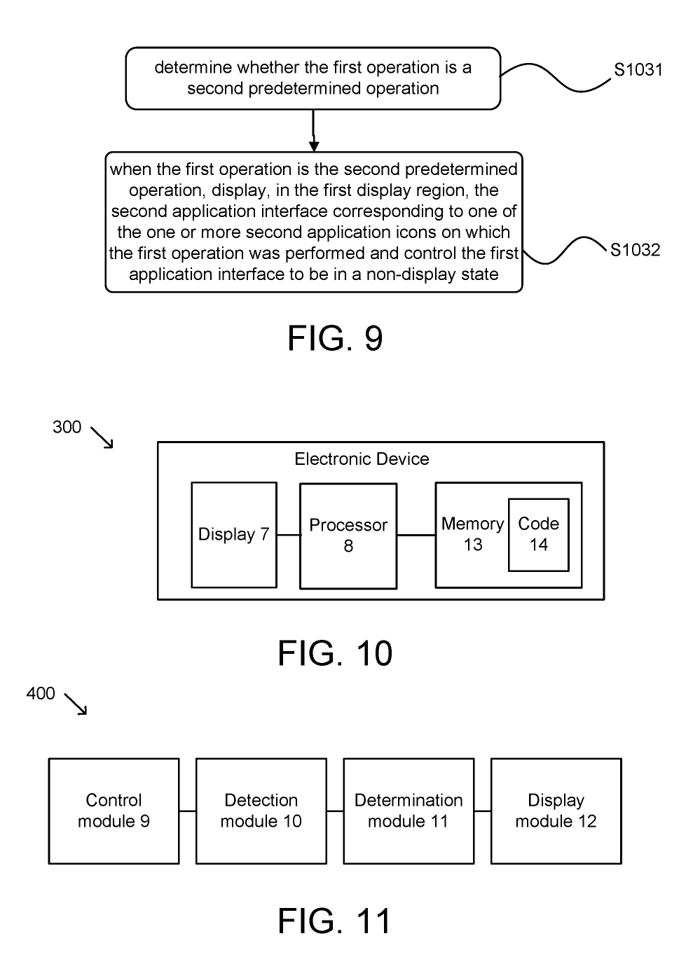

FIG. 1C is a schematic flow chart diagram illustrating an overview of various steps depicted in other figures, of a method 100′ of controlling display regions of an electronic device. FIG. 1C refers to steps that are described in more detail in other figures using the same or corresponding reference numbers. For example, a reference to a step S1032′ in FIG. 1C may be understood to refer to the same step S1032 in FIG. 9.

While a particular order of the steps is shown in FIG. 1C, in some embodiments, the steps showing in FIG. 1C may be performed in another order unless otherwise clearly indicated from the context of the description of the steps. Moreover, the method 100′ may be performed with some of the steps omitted unless it is clear from the context that a step is required. More detail regarding the steps illustrated in FIG. 1C is provided in the figures referred to in FIG. 1C and the accompanying description. FIG. 1C is provided merely to provide an exemplary overview of some embodiments of the method 100′.

In some embodiments, the method 100′ begins and may include detecting S102′, on a display of an electronic device configured to display a first application interface corresponding to a first application and a shortcut interface comprising one or more second application icons, a first operation performed on one of the one or more second application icons. In the embodiments, the method 100′ may further include determining S103′ whether the first operation satisfies a predetermined condition and defining S103″ a first display region and a second display region in response to determining that the first operation satisfies the predetermined condition. A more detailed description of these steps is provided above with respect to steps S102, S102′ and S103, S103′ in FIGS. 1A,1B.

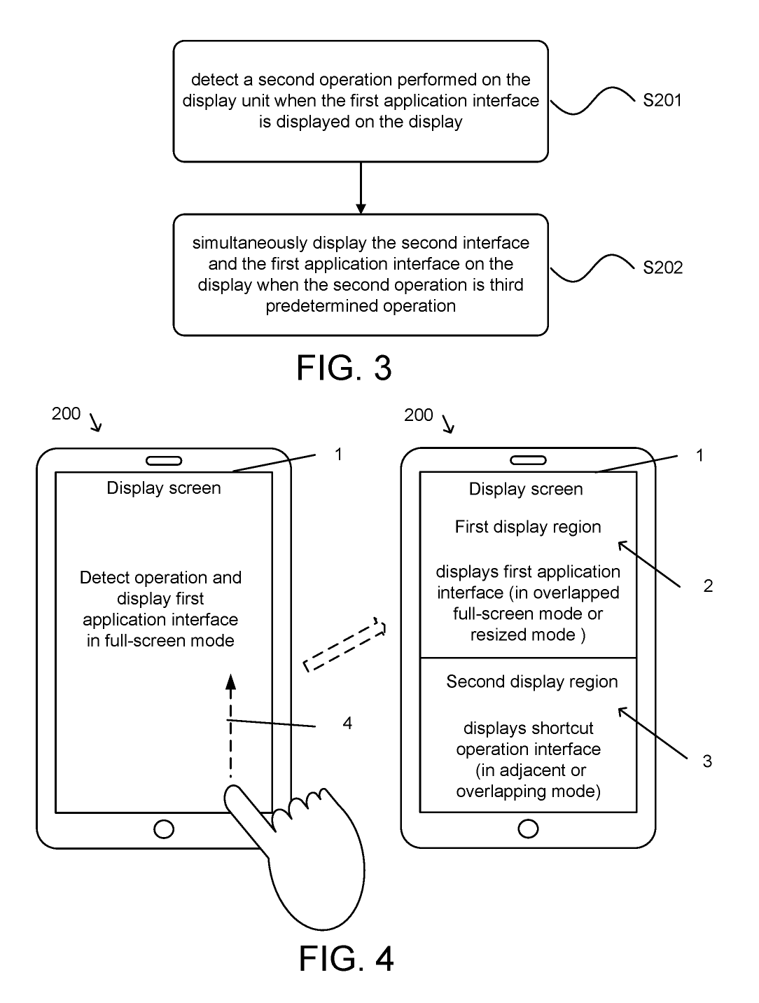

In some embodiments, the method 100′ may further include determining S203′ which of the one or more second application icons to display in the shortcut interface based on a predetermined rule. A more detailed description is provided below with respect to the step S203 depicted in FIG. 3. In some embodiments, the method 100′ includes determining S103′ whether the first operation satisfies a predetermined condition, where determining whether the first operation satisfies a predetermined condition includes determining whether the first operation is one of a first predetermined operation selected from the group consisting of taps, swipes, presses, and combinations thereof, and a second predetermined operation selected from the group consisting of taps, swipes, presses, and combinations thereof.

More detail regarding steps S103′,S103″ is provided above with respect to a first operation being a first predetermined operation above with respect to FIGS. 1A and 1B. More detail is provided below with respect to a first operation being a second predetermined operation below with respect to FIG. 9.

In some embodiments of the method 100′, the first predetermined operation is a swipe operation from a display position of the second application icon (e.g. one of the one or more second application icons on with the operation is performed) to the first display region, and the second predetermined operation is a tap operation on the shortcut interface with respect to the second application icon. In other embodiments, the first predetermined operation is a tap operation on the shortcut interface with respect to the second application icon, and the second predetermined operation is a swipe operation from a display position of the second application icon to the first display region. In other words, the order of a tap operation and a swipe operation may be reversed in some embodiments.

In some embodiments, the method 100′ further includes defining the first display region and the second display region such that the second display region does not overlap the first display region, in response to determining that the first operation is the first predetermined operation. More detail is provided above with respect to FIGS. 1A, 1B.

In some embodiments, the method 100′ further includes displaying S104′, in the first display region, an interface related to the first application interface. In some embodiments, displaying an interface related to the first application interface may refer to displaying the first application interface in the first display region. In other embodiments, displaying an interface related to the first application interface may refer to displaying S1041′ a resized first application interface in the first display region. See for example the description of S1041 and S1042 shown in FIG. 6 and described below regarding adjusting the size of the first application interface and displaying it in the first display region. As noted above, in some embodiments of the method 100′, steps may be omitted or performed in a different order than depicted in FIG. 1C.

In some embodiments, the method 100′ may further include displaying S104′, in the second display region, a second application interface of a second application corresponding to one of the one or more second application icons. See, for example, step S104′ described above with respect to FIG. 1A.

In other embodiments, the method 100′ further includes controlling the shortcut interface to be in a non-display state. In other words, display of the shortcut interface may be turned off so that display only displays the active application interfaces and not the shortcut interface. See, for example, the description of FIG. 6 below regarding controlling the second interface (e.g. the shortcut interface) to be in a non-display state.

In some embodiments, displaying S104′, in the first display region, an interface related to the first application interface in the method 100′ includes one of acquiring S1041′ a resized first application interface that fits within the first display region and displaying S1042′ the resized first application interface in the first display region. See, for example, steps S1041, S1042 described below with respect to FIG. 6.

In other embodiments, displaying S104′, in the first display region, an interface related to the first application interface in the method 100′ includes displaying a portion of the first application interface in the first display region. See, for example, step S104 described below with respect to FIG. 6.

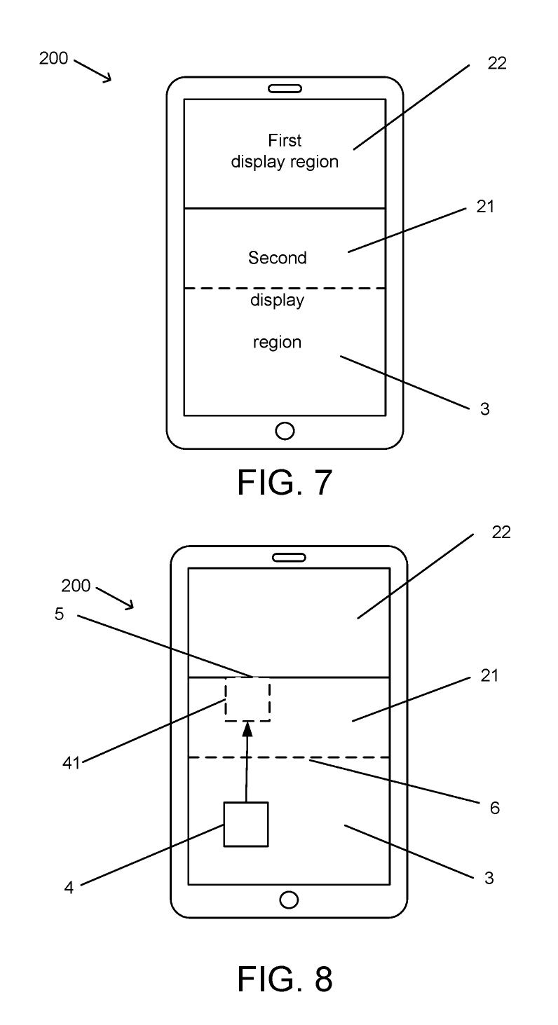

In some embodiments, the method 100′ includes a first sub-region of the first display region that is displaced by a resized second display region so as to define a resized first display region, i.e. a display region in which the size has been adjusted. See, for example, steps S1041 and S1042 describe below with respect to FIG. 6 and sub-region 21 described below with respect to FIGS. 7, and 8. In some embodiments of the method 100′, a line defining an intersection of the resized first display region and the resized second display region is determined to be at an ending position of the first predetermined operation performed on one of the one or more second application icons. See the description below with respect to FIGS. 7 and 8.

In some embodiments, the method 100′ may further include detecting S201′ a second operation performed on the display when the first application interface is displayed on the display. In the embodiments, the method 100′ may further include displaying S202′ the first application interface and the shortcut interface on the display in response to the second operation comprising a third predetermined operation selected from the group consisting of taps, swipes, presses, and combinations thereof. See for example the description below with respect to FIG. 3. It may be noted by one of skill in the art that as described below with respect to FIG. 3, the steps S201, S202 may be performed at a time when a second operation is a third predetermined operation, e.g. an operation different from the first and second predetermined operations referred to above, whether or not performed in the order shown in FIG. 1C.

In some embodiments, the method 100′ may further include, in response to determining S103′ that the first operation is the second predetermined operation, displaying S1031′, in a first display region, a second application interface of a second application corresponding to one of the one or more second application icons. In the embodiments, the method 100′ may further include controlling S1032′ the first application interface to be in a non-display state. In some embodiments, the second application corresponding to a second application icon of the one or more second application icons may be displayed in the first display region and the first application may be controlled to be in a non-display state and the method 100′ ends. See the description below with respect to FIG. 9,

Thus, the various embodiments of the method 100′ may include some or all of the steps described above with respect to FIG. 1C, and/or described with respect to the other figures as set forth above.

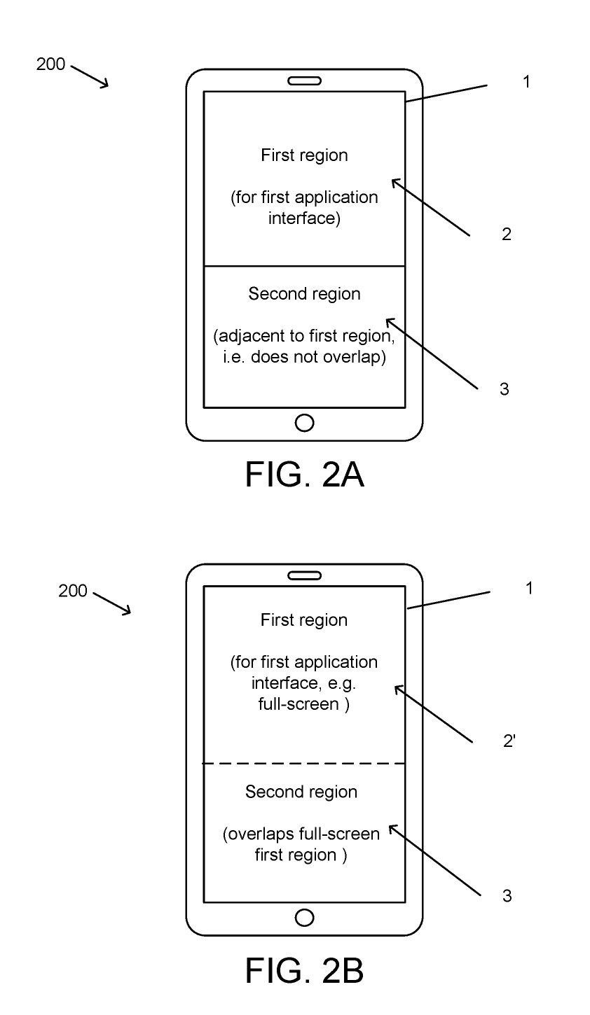

FIG. 2A is a schematic block diagram illustrating a display screen 1 of an electronic device 200 displaying a first display region 2 and a second display region 3 that does not overlap the first display region 2. In some embodiments, the first display region 2 and the second display region 3 may be defined as illustrated such that the first display region 2 and the second display region 3 are adjacent to each other, but do not overlap.

FIG. 2B is a schematic block diagram illustrating a display screen 1 of an electronic device 200 displaying a first display region 2′ that includes the entire display screen of the electronic device and a second display region that overlaps the first display region. In some embodiments, the first display region 2′ and the second display region 3 may be regions that overlap on the display screen 1. As illustrated in FIG. 2B, the first display region 2B includes the entire display region of the display screen 1 of the electronic device 200 (e.g. mobile phone), and the second region 3 is a display region that overlaps first display region 2′ to the dashed-line portion in the first display region 2′.

FIG. 3 is a schematic flow chart diagram illustrating additional steps that may be performed before the first step S101 of the method 100 in the embodiment of FIG. 1. In some embodiments, the method 100 may include additional steps before step S101. For example, the method 100 may include detecting S201 a second operation performed on the display when the first application interface is displayed on the display and simultaneously displaying S202 the second application interface and the first application interface on the display when the second operation is a third predetermined operation.

For example, after an application interface corresponding to any one application in the electronic device 200 is displayed on the display screen 1, the electronic device 200 may call the shortcut operation interface by detecting and responding to a predetermined operation performed on the application interface, such as a tap operation, a swipe operation, a press operation, and the like, such that the electronic device 200 controls the display screen to simultaneously display the application interface corresponding to any one application (e.g. first application interface 2 in either full-screen or resized) mode) and a shortcut operation interface (e.g. second application interface).

FIG. 4 is a schematic block diagram illustrating an operation for switching an electronic device from displaying a single first application interface to simultaneously displaying the first application interface and a shortcut operation interface (also referred to as a “shortcut interface”) on the display screen of the mobile device.

In some embodiments, referring to FIG. 4, when the electronic device 200 (e.g. a mobile phone) detects that a user performs a tap operation (or another predetermined operation) for the first application icon on a display screen 1, the electronic device 200 may respond to the first application corresponding to the first application icon, runs the first application, and displays in full screen the first application interface of the first application in a display screen 1.

When the display screen 1 of the electronic device 200 (e.g. mobile phone) displays the first application interface in full-screen mode or in some embodiments in another mode, the electronic may detect a shortcut operation beginning at identifier 4 performed on the first application interface, such as for example, swiping from the edge of the display screen of the electronic device (e.g. mobile phone) to the interior of the display screen. In response, the electronic device may determine whether the shortcut operation is a predetermined operation.

In some embodiments, the predetermined operation may be a shortcut operation to call a shortcut operation interface, in which case the electronic device may directly display the shortcut operation interface in a second region 3, on the display screen 1. In one embodiment, the first application interface in the first display region 2 may still be in a full screen display mode, but a first portion of the first application interface in the first display region 2 is covered by the shortcut operation interface displayed in the second display region 3.

A second portion of the first application interface is not covered by the shortcut operation interface and is displayed in the first display region 2. In some embodiments, the shortcut operation interface displayed in the second region 3 is in a running state. In the embodiments, the first application interface may be in a suspended state (which may be also referred to a pending state or a waiting state). In some embodiments, the first application interface may be darkened, so that the brightness of the first application interface visible in the uncovered portion of the first display region 2 is lower than the brightness of the shortcut operation interface displayed in the second region 3, for ease of differentiation and operation.

In some embodiments, the electronic device 200 (e.g. a mobile phone) may simultaneously control the shortcut operation interface displayed in the second region 3 to be in a running state, and control the first application interface in the first display region 2 (whether in full-screen or resized mode) to be in a running state. In this case, the display luminance or brightness, of a portion of interface of the first application interface displayed in the first display region 2 may be defined to be consistent with the brightness of the shortcut operation interface displayed in the second display region 3, or the brightness of a portion of interface of the first application interface displayed in the first region 2 may be different that the brightness of the shortcut operational interface displayed in the second display region 3, for ease of differentiation and operations.

In some embodiments, when the shortcut operation interface is directly displayed in the second display region 3, the electronic device may control the first application interface to be in a non-full screen display state. For example, the size of the first application interface is resized, such that the size of the resized first application interface is just consistent with the size of the first display region 2, e.g. not overlapped by the second display region 3, so that the entire first application interface may be displayed in the first region 2.

In some embodiments, the electronic device 200 may allow only the shortcut operation interface displayed in the second region 3 to be in a running state. Thus, the electronic device 200 may cause the first application interface to be in a suspended state and may also darken the first application interface.

In other embodiments, the electronic device may simultaneously control the shortcut operation interface in the second region 3 and the first application interface in the first region 2 to be in a running state, and may set the brightness of the first application interface displayed in the first display region 2 to be the same as or different from the brightness of the shortcut operation interface displayed in the second display region 3.

Thus, in the various embodiments described above, the display screen 1 of the electronic device 200 is capable of conveniently entering a screen-split mode, that is, displaying the first application interface and the shortcut operation interface simultaneously. Moreover, in some embodiments, when the display screen of the electronic device (e.g. mobile phone) is in the screen-split mode, various applications in the screen-split mode may be controlled to be in a running state, or one application in the screen-split mode may be controlled to be in a running state and another application in the screen-split mode may be controlled to be in a suspended state.

In another exemplary embodiment, the second display region 3 of the display screen 1 directly displays the shortcut operation interface, and also directly displays a resized first application interface in the first display region 2. In the embodiment, the shortcut operation interface is in a running state, the first application interface is in a suspended state, and the shortcut operation interface includes a second application icon corresponding to a second application and a third application icon corresponding to a third application.

When the electronic device 200 detects that a user performs a tap operation (or another predetermined operation) for the second application icon in the display screen 1, the electronic device 200 may run the second application, and display in full screen the second application interface of the second application on the display screen 1, The in response to determining that a detected operation is a predetermined shortcut operation, the electronic device (e.g. mobile phone) may call the shortcut operation interface and enter a screen-split display state.

Then in response to detecting an operation performed by the user for the third application icon, the electronic device may display the third application interface in full screen. Thus, by detecting various operations and determining whether they satisfy predetermined conditions, the electronic device may switch between full-screen and spilt-screen modes and may further switch between first, second, third and/or more application interfaces to be displayed with convenient sizes and brightness.

Moreover, a person skilled in the art may understand that the application icons comprised in the shortcut operation interface of the electronic device (e.g. mobile phone) may be flexibly defined according to the particular needs. For example, when the display screen of the electronic device (e.g. mobile phone) is simultaneously displaying the first application interface in the first display region and displaying the shortcut operation interface in the second region, the shortcut operation interface may include only one application icon corresponding to a second application or may a plurality of application icons corresponding to a plurality of applications, e.g., second, third, or more applications.

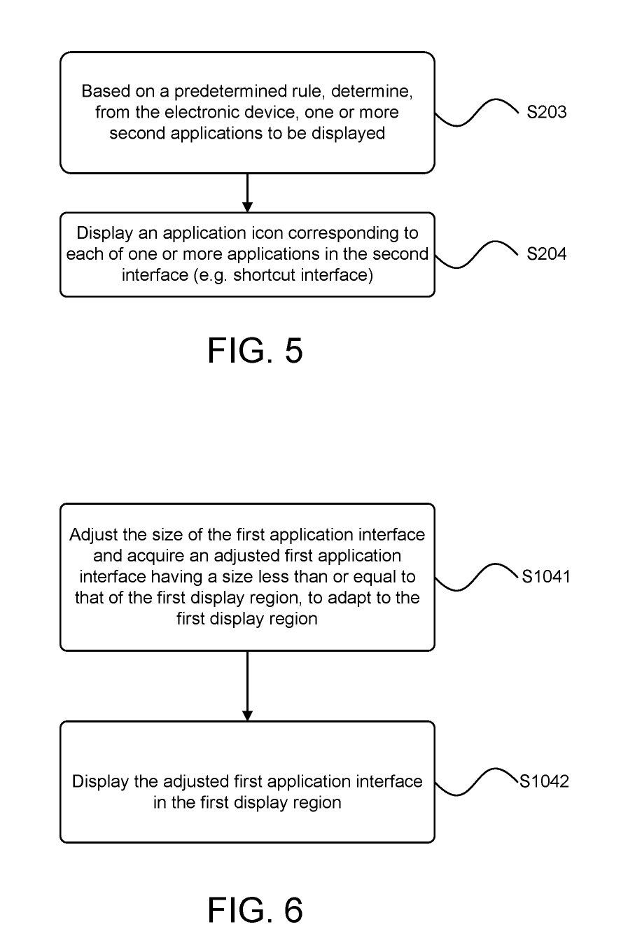

FIG. 5 is a schematic flow chart diagram of steps for determining which application icons are to be displayed in the shortcut interface in some embodiments, such as for example, the embodiments depicted in FIGS. 1A, 1B, 1C, and the other figures referred to in FIG. 1C and corresponding descriptions.

Referring to FIG. 5, in some embodiments, the application icon displayed in the shortcut operation interface as illustrated in FIG. 4 may also be determined in the following manner. In some embodiments, the step S203 includes, based on a predetermined rule, determining, from the electronic device, at least one application comprising the second application. In some embodiments, step S204 includes, displaying an application icon corresponding to each of the at least one application in the second interface. FIG. 1C depicts a similar step S203′.

In one embodiment, still using the above example, applications displayed in the shortcut operation interface may be determined according to a descending sequence of the usage frequencies of the various applications in the electronic device (e.g. mobile phone). For example, the application icons of all the applications with the usage frequencies higher than a predetermined value in the electronic device (e.g. mobile phone) are displayed on the shortcut operation interface.

In the example, when the predetermined value is ten times, the usage frequency of the first application in the electronic device (e.g. mobile phone) is six times, the usage frequency of the second application in the electronic device (e.g. mobile phone) is twelve times and the usage frequency of the third application in the electronic device (e.g. mobile phone) is sixteen times, the usage frequency of the second application and the usage frequency of the third application are both greater than the predetermined ten times, and in this case, the electronic device (e.g. mobile phone) may display the second application icon corresponding to the second application and the third application icon corresponding to the third application in the shortcut operation interface.

In some embodiments, the electronic device (e.g. mobile phone) may also determine the applications displayed in the shortcut operation interface according to a sequence of the recently used applications in the electronic device (e.g. mobile phone). For example, the applications that have been used within the latest three hours are displayed on the shortcut operation interface. In the example, when the applications that have been used within the latest three hours are sequentially the first application, the second application and the third application, since the first application, the second application and the third application all have been used within the latest three hours, the first application icon corresponding to the first application, the second application icon corresponding to the second application and the third application icon corresponding to the third application are sequentially displayed in the shortcut operation interface or randomly displayed in the shortcut operation interface.

In some embodiments, default applications may be displayed in the shortcut operation interface according to default settings in the electronic device (e.g. mobile phone), or the applications displayed in the shortcut operation interface may be determined according to an associated program of the applications displayed in the current electronic device (e.g. mobile phone) or another rule, which is not illustrated exhaustively herein and is subject to no limitation herein.

In some embodiments, when the screen of the electronic device (e.g. mobile phone) is relatively larger, for convenience for the user to call the shortcut operation interface, the operation position of the shortcut operation for calling the shortcut operation interface may be configured to a position which facilitates user's operations. For example, when the operation position of the shortcut operation is configured in the electronic device (e.g. mobile phone) used by the user, the thumb of the user is generally placed on the screen of the electronic device (e.g. mobile phone). In some embodiments, the called shortcut operation interface may also be displayed at the position which facilitates user's operations, for example, displayed in a region corresponding to calling the shortcut operation on the display screen of the electronic device (e.g. mobile phone). In some embodiments, the shortcut operation interface is displayed in a region close to the edge of the display screen or displayed in the edge region of the display screen facilitating user's operations with fingers, which is not limited herein any further.

After step S101 is performed, step S102 in the method according to the embodiment of the present application is performed, that is, detecting and acquiring a first operation performed for the second application icon.

In some embodiments, in the example described above, the display screen of the electronic device (e.g. mobile phone) displays the first application interface and the shortcut operation interface comprising the second application icon and the third application icon, the user may perform an operation for the second application icon on the shortcut operation interface. In this case, the electronic device (e.g. mobile phone) may detect the operation performed by the user for the second application icon.

The user may also perform an operation for the third application icon on the shortcut operation interface, then the electronic device (e.g. mobile phone) may detect the operation performed by the user for the third application icon. Herein, the scenario where the user performs an operation for the second application icon on the shortcut operation interface is specifically used as an example, and the electronic device (e.g. mobile phone) may detect the operation performed by the user for the second application icon on the shortcut operation interface.

In some embodiments, after step S102 is performed, step S103 in the method according to the embodiment of the present application may be performed, that is, determining whether the first operation satisfies a first predetermined condition, and when the first operation satisfies the first predetermined condition, determining, from the display, a first display region and a second display region that does not overlap the first display region.

In some embodiments, still using the above example, specifically, after the electronic device (e.g. mobile phone) detects the operation performed by the user for the second application icon on the shortcut operation interface, the electronic device (e.g. mobile phone) may determine, i.e. determine, whether this operation satisfies a predetermined condition.

For ease of description, herein the operation performed by the user for the second application icon on the shortcut operation interface may be referred to as the first operation, and in some embodiments, the process by which the electronic device (e.g. mobile phone) determines whether the first operation satisfies the predetermined condition may include determining whether the first operation is a first predetermined operation. In some embodiments, the first predetermined operation may be a swipe operation from a display position of the second application icon to the first region. Alternatively, the first predetermined operation may be a tap operation on the second interface with respect to the second application icon.

In some embodiments, still using the above example, after the electronic device (e.g. mobile phone) detects the first operation performed by the user for the second application icon on the shortcut operation interface, the electronic device (e.g. mobile phone) may determine whether the first operation is a first predetermined operation. In some embodiments, the first predetermined operation may be a swipe operation for swiping the second application icon from the position where the second application icon on the shortcut operation interface is located to the region where the first application interface is located, or may be a tap operation for directly tapping the second application icon at the position where the second application icon on the shortcut operation interface is located.

In some embodiments, in addition to the above swipe operation from the position where the second application icon is displayed to the first region or the tapping operation performed for the second application icon on the second interface, the first predetermined operation may also be a press operation for directly pressing the second application icon at the position where the second application icon on the shortcut operation interface is located, or another operation, which is not listed exhaustively herein any further.

For example, when the first operation is the swipe operation for swiping the second application icon from the position where the second application icon on the shortcut operation interface is located to the region where the first application interface is located, the electronic device (e.g. mobile phone) may firstly select, in the shortcut operation interface, the second application icon corresponding to the second application, wherein the manner for selecting the second application icon may be pressing the second application icon for an extended period of time or another predetermined selection manner. After the second application icon is selected on the shortcut operation interface of the electronic device (e.g. mobile phone), the second application icon is swiped from the position where the second application icon on the shortcut operation interface is located to the region where the first application interface is located.

In this way, the electronic device (e.g. mobile phone) may determine whether the first operation is a swipe operation. Herein, assume that the first operation detected by the electronic device (e.g. mobile phone) is the above swipe operation for the second application icon, then the electronic device (e.g. mobile phone) may determine two display regions that do not overlap from the display screen of the electronic device (e.g. mobile phone).

Herein, for ease of description, the two non-overlapping display regions that are selected by the electronic device (e.g. mobile phone) from the display screen may be respectively referred to as a first display region and a second display region, or alternatively as a first region and a second region of the display. Afterwards, the electronic device (e.g. mobile phone) may perform step S104 in the method according to the embodiment of the present application, that is, displaying, in the second display region, a second application interface of a second application corresponding to the second application icon, and displaying, in the first display region, an interface related to the first application interface.

In some embodiments, still using the above example, specifically, after the electronic device (e.g. mobile phone) determines that the first operation is the first predetermined operation, that is, the swipe operation for swiping the second application icon from the position where the second application icon on the shortcut operation interface is located to the region where the first application interface is located, and the electronic device (e.g. mobile phone) determines the first display region and the second display region from the display screen of the electronic device (e.g. mobile phone), the electronic device (e.g. mobile phone) may display the second application interface corresponding to the second application in the second display region, and display the interface related to the first application program in the first display region. In some embodiments, the displaying the interface related to the first application in the first display region in step S104 may be implemented in the following two manners.

FIG. 6 is a schematic flow chart diagram of a one embodiment of steps for displaying in a second display region an application interface of a second application corresponding to a second application icon. In some embodiments, the steps for displaying in a second display region an application interface of the second application corresponding to a second application icon include adjusting S1041 the size of the first application interface and acquiring an adjusted first application interface having a size less than or equal to that of the first display region, to adapt to the first display region. In some embodiments, the steps further include displaying S1042 the adjusted first application interface in the first display region. Corresponding steps S1041′, S1042′ may be found in FIG. 1C, to which the descriptions found below apply unless otherwise clear from the context.

In some embodiments, the electronic device (e.g. mobile phone) may display the second application interface corresponding to the second application in the second display region, the electronic device (e.g. mobile phone) may also resize the first application interface corresponding to the first application, such that the size of the resized first application interface is just consistent with the size of the first display region. As such, the first display application interface of the resized first application interface which is a complete display interface is completely displayed in the first display region, and the display screen of the electronic device (e.g. mobile phone) is capable of simultaneously displaying the first application interface and the second application interface, such that the display screen of the electronic device (e.g. mobile phone) is in a screen-split state.

In some embodiments, the electronic device (e.g. mobile phone) may control the first application interface displayed in the first display region and the second application interface displayed in the second display region to be both in a running state; or when the first application interface and the second application interface in the electronic device (e.g. mobile phone) are both in the running state, through a predetermined operation, the first application interface and the second application interface that are both in the running state may be defined to be in a non-running state, or one of the first application interface and the second application interface is defined to be in the running state.

For example, when the first application interface is displayed on the left side of the display screen and the second application interface is displayed on the right side of the display screen, a leftward swipe or a rightward swipe is performed on the display interface of the electronic device (e.g. mobile phone), such that the first application interface of the display screen of the electronic device (e.g. mobile phone) is in a running state and the second application interface is in a non-running state, or the first application interface is in a non-running state and the second application interface is in a running state.

Continuing with the example, when the first application interface is displayed on the left side of the display screen and the second application interface is displayed on the right side of the display screen, a upward swipe is performed for the first application interface on the first application interface of the display screen of the electronic device (e.g. mobile phone), such that the first application interface on the display screen of the electronic device (e.g. mobile phone) is in a non-running state and the second application interface is in a running state and the like.

In some embodiments, the electronic device (e.g. mobile phone) may also control the first application interface displayed in the first display region to be in a running state, and control the second application interface to be in a suspended state (which is also referred to as a pending state or a waiting state); or the electronic device (e.g. mobile phone) may subject the second application interface to a darkening treatment, such that the display luminance of the first application interface is higher than the display luminance of the second application interface, for ease of differentiation and operations.

Likewise, when the first application interface on the display screen of the electronic device (e.g. mobile phone) is in a running state and the second application is in a suspended state, the electronic device (e.g. mobile phone) may, through a predetermined operation, implement control of the switching of the application interface in the current running state. For example, when the electronic device (e.g. mobile phone) detects that a tap operation is performed on the second application interface in the suspended state, the electronic device (e.g. mobile phone) may control the second application interface to be in the running state and control the first application interface to be in the suspended state and the like.

Likewise, the electronic device (e.g. mobile phone) may also control the second application interface to be in the running state and control the first application interface to be in the suspended state, and the electronic device (e.g. mobile phone) may define the display luminance of the first application interface to be consistent or inconsistent with the display luminance of the second application interface. In addition, the electronic device (e.g. mobile phone) may also, through a predetermined operation, implement control of the switching of the application interface in the current running state, which is not described herein any further.

Therefore, as described above, when the electronic device (e.g. mobile phone) performs an operation for switching the second application program for the second application icon in the shortcut operation interface, the electronic device (e.g. mobile phone) is capable of simultaneously and completely displaying the first application interface corresponding to the application before switching, and the second application interface corresponding to the application after switching. In this way, the technical problem that the display effect is singular may be addressed, and the application interface in the running state may be flexibly controlled and selected when the electronic device (e.g. mobile phone) simultaneously displays the first application interface and the second application interface, that is, in a screen-split display state.

In some embodiments, after step S104 is performed, the method according to this embodiment may further include controlling the second interface, i.e. the shortcut interface to be in a non-display state.

For example, when the electronic device (e.g. mobile phone) displays the first application interface with a compacted size in the first display region, and displays the second application interface of the second application corresponding to the second application icon in the second display region, the electronic device (e.g. mobile phone) may further control the shortcut operation interface to be in a non-display state.

Referring again to FIG. 6, one embodiment of displaying the interface related to the first application in the first display region in step S104 includes displaying a portion of the first application interface in the first display region.

In some embodiments, in addition to resizing the size of the first application interface corresponding to the first application to adapt to the size of the first display region as illustrated in FIG. 6, the electronic device (e.g. mobile phone) may further not resize the first application interface corresponding to the first application, and display a portion of interface in the first application interface according to the size of the first display region. For example, after the electronic device (e.g. mobile phone) determines the first display region and the second display region, the electronic device (e.g. mobile phone) does not perform any operation for the first application interface, but allows the first display region to directly display a portion of region in the first application interface corresponding to the first display region; or after the electronic device (e.g. mobile phone) determines the first display region and the second display region, the electronic device (e.g. mobile phone) moves any portion of region which is consistent with the first display region in terms of size in the first application interface to the first display region for display or the like.

In some embodiments, after the electronic device (e.g. mobile phone) does not perform any operation for the first application interface, but allows the first display region to directly display a portion of region in the first application interface corresponding to the first display region, and displays the second application interface of the second application corresponding to the second application icon in the second display region, the electronic device (e.g. mobile phone) may further control the shortcut operation interface to be in a non-display state.

In one embodiment, for example, using the scenario where the first application interface may be resized, and the size of the resized first application interface may be made consistent with the size of the first display region, such that the compacted first application interface just fits the first display region, and the region for displaying the first application interface on the display screen of the electronic device (e.g. mobile phone) in step S101 is the first region, the region for displaying the shortcut operation interface is the second region, and the first region and the second region are regions adjacent to each other, but do not overlap (as illustrated in FIG. 2A). As an example, the second display region in step S104 may at least comprise a first sub-region of the first region and a second sub-region of the second region, wherein the first sub-region and the second sub-region are adjacent sub-regions.

That is, the second display region determined by the electronic device (e.g. mobile phone) may comprise the second region corresponding to the shortcut operation interface, and another sub-region adjacent to the second region in the first region corresponding to the first application interface.

FIG. 7 is a schematic block diagram illustrating one embodiment of determining a resized first display region and a resized second display region. It will be understood by person of ordinary skill that the term resizing or resized relates to having the size adjusted. Specifically, referring to FIG. 7, in combination with FIG. 2A, as illustrated in FIG. 7, the second display region comprises the second region 3 corresponding to the shortcut operation interface and a sub-region 21 adjacent to the second region 3 in the first region. In this case, a sub-region 22 remaining in the first region is the first display region, and is used for displaying, for example, the first application interface with a resized or adjusted size, or is used for displaying a portion of display interface in the first application interface that is not resized.

FIG. 8 is a schematic block diagram of determining the position of a line between a resized first display region and a resized second display region based on an ending point of an operation performed on one of the one or more second application icons. In other words, when an icon is moved from the shortcut interface, which may in some embodiments be a very small region on the display, to a point in the first display region, the line that defines a second display region may be determined by the ending point of the operation performed on the second application icon. As previously described the operations may include taps, swipes, presses and so forth.

For example, in some embodiments, referring to FIG. 8, the sub-region 21 in the first region, as illustrated in FIG. 7, which is used for displaying the second application interface together with the second region may be determined through the following steps:

A: determining that an operation end point of the swipe operation is at a first position of the display;

B: when the first position is in the first region, determining a straight line that passes through the first position and is parallel to an intersection line between the first region and the second region, wherein the first region intersects, but does not overlap the second region; and

C: based on the straight line, partitioning, from the first region, the first sub-region adjacent to the second sub-region.

Referring to FIG. 7 and FIG. 8, the electronic device (e.g. mobile phone) may determine that the swipe operation from the display position of the second application icon to the first application interface is ended at a specific position on the display screen. Specifically, as illustrated in FIG. 8, an identifier 4 indicates the position of the second application icon in the shortcut operation interface. The dashed arrow in FIG. 8 indicates swiping the second application icon in the shortcut operation interface from the display position thereof in the shortcut operation interface to the first application interface.

An identifier 41 indicates the position of the second application icon in the first application interface after swiping the second application icon to the first application interface, wherein the identifier 41 is the end position of the swipe operation for the second application icon determined by the electronic device (e.g. mobile phone). In addition, the electronic device (e.g. mobile phone) needs to further determine the end position, that is, determine whether the identifier 41 is in the first region. If the identifier 41 is in the first region, the electronic device (e.g. mobile phone) determines a straight line 5 at the position indicated by the identifier 41, wherein the straight line 5 is parallel to an intersection line 6 between the first region and the second region.

Afterwards, the electronic device (e.g. mobile phone) uses the straight line 5 as a reference line, and partitions the first region into a sub-region 21 and a sub-region 22 that is adjacent to the sub-region 21. As such, the sub-region 21 in the first region and the second region 3 of the display screen are the determined second display region, which is used for displaying the second application interface, and the sub-region 22 in the first region is the determined first display region, which is used for displaying the interface related to the first application interface.

In some embodiments, still using the above example, in some embodiments, when it is determined whether the first operation satisfies the first predetermined operation, wherein the first predetermined operation is specifically a tap operation for directly tapping the second application icon at the position where the second application icon on the shortcut operation interface is located, the electronic device (e.g. mobile phone) may further perform the following steps after detecting that the first operation performed by the user for the second application icon is a tap operation:

when the first operation satisfies the first predetermined condition, determining, from the display, a first display region and a second display region that does not overlap the first display region; and

displaying, in the second display region, a second application interface of a second application corresponding to the second application icon, and displaying, in the first display region, an interface related to the first application interface.

In some embodiments, after the electronic device (e.g. mobile phone) determines that the first operation is a tap operation, the electronic device (e.g. mobile phone) may determine two display regions that do not overlap from the display screen of the electronic device (e.g. mobile phone). Herein, for ease of description, the two non-overlap display regions that are determined from the display screen of the electronic device (e.g. mobile phone) may be respectively referred to as a first display region and a second display region. The electronic device (e.g. mobile phone) may display the second application interface corresponding to the second application in the second display region, and display the interface related to the first application in the first display region.

Likewise, the displaying the interface related to the first application in the first display region may also be implemented in the two manners described above, that is, resizing the size of the first application interface corresponding to the first application, such that the size of the compacted first application interface is just consistent with the size of the first display region. As such, the compacted first application interface which is a complete display interface may be completely displayed in the first display region, or the first application is not compacted, and a portion of interface in the first application interface may be directly displayed according to the size of the first display region, which is not described herein any further.

FIG. 9 is a flow diagram of steps for displaying a second application corresponding to a second application icon in the first display region and controlling the first application to be in a non-display state. In some embodiments, still using the above example, referring to FIG. 9, when step S103, S103′ in the embodiments of the method 100, 100′ is performed, that is, determining whether the first operation satisfies a first predetermined condition, the following steps may also be performed.

In some embodiments, the step S1031 includes determining whether the first operation is a second predetermined operation. In some embodiments, the step S1032 further includes, when the first operation is the second predetermined operation, displaying, in a first region corresponding to the first application interface, the second application interface of the second application corresponding to the second application icon, and controlling the first application interface to be in a non-display state.

Specifically, during determining whether the first operation is a first predetermined operation, when the electronic device (e.g. mobile phone) determines that the first operation is not the first predetermined operation, the electronic device (e.g. mobile phone) may further determine whether the first operation is a second predetermined operation. Herein, assume that the first predetermined operation is a swipe operation for swiping the second application icon from the position where the second application icon on the shortcut operation interface is located to the region where the first application interface is located, or the second predetermined operation is a tap operation for directly tapping the second application icon at the position where the second application icon on the shortcut operation interface is located.

Then, when the electronic device (e.g. mobile phone) determines that the first operation is not a swipe operation, and further determines that the first operation is a tap operation, the electronic device (e.g. mobile phone) may control the first region for displaying the first application interface on the display screen of the electronic device (e.g. mobile phone) to display the second application interface of the second application corresponding to the second application icon.

The electronic device (e.g. mobile phone) may further control the previous displayed first application interface to be in a non-display state, and the second region of the electronic device (e.g. mobile phone) may further display the shortcut operation interface. In some embodiments, when the electronic device (e.g. mobile phone) determines that the first operation is a tap operation, the electronic device (e.g. mobile phone) may use the entire display screen thereof to display the second application interface of the second application corresponding to the second application icon, that is, the first region and the second region of the display screen are both used for displaying the second application interface.

FIG. 10 is a schematic block diagram of one embodiment of a system 300 for controlling display regions of an electronic device 200 using the methods described above, e.g., methods 100,100′ with respect to FIGS. 1A-10. In one embodiment, the system 300 includes a display 7, a processor 8, where the processor is configured to display a first application interface corresponding to a first application and a shortcut interface comprising one or more second application icons, and a memory 13 storing code 14 that is executable by the processor to perform detecting, on the display, a first operation performed on one of the one or more second application icons.

In the embodiment, the code 14 is further executable by the processor to perform determining whether the first operation is one of a first predetermined operation selected from the group consisting of taps, swipes, presses, and combinations thereof, and a second predetermined operation selected from the group consisting of taps, swipes, presses, and combinations thereof. The code 14 is further executable to perform defining a first display region and a second display region based on the first operation.

In some embodiments, the code 14 is executable by the processor 8 to further perform determining which of the one or more second application icons to display in the shortcut interface, based on a predetermined rule. For example, the code may the executable by the processor 8 to perform steps S203 and S204 as described above with respect to FIGS. 1C, 4, 5. For example based on the frequency of usage of a particular second application of the one or more second applications.

In some embodiments, in response to determining that the first operation is a first predetermined operation the code 14 is executable by the processor 8 to further perform defining the second display region such that it does not overlap the first display region. The code is further executable to perform displaying, in the first display region, an interface related to the first application interface and displaying, in the second display region, a second application interface of a second application corresponding to one of the one or more second application icons. In other words, the code 14 is executable by the processor 8 to control the display 7 to operate in split screen mode where a first application is displayed in the first display region and the second application of the one or more second applications is displayed in the second display region in much the same manner as described above with respect to FIG. 6.

In some embodiments, of the system 300 further includes code 14 that is executable by the processor 8 to perform displaying, in the first display region, an interface related to the first application interface, which includes one of acquiring a resized first application interface that fits within the first display region and displaying the resized first application interface in the first display region, and displaying a portion of the first application interface in the first display region. In other words, the first display region is used to display a portion of the first application.

In some embodiments, the system 300 further includes code 14 is executable by the processor 8 to further perform defining a resized first display region and a resized second display region in response the first operation, wherein a line defining an intersection of a resized first display region and a resized second display region is determined to be at an ending position in the first display region of the first predetermined operation performed on one of the one or more second application icons. Thus, in these embodiments which are described above with respect to FIGS. 7-8, the system 300 provides the user with a way to resize the first display region by using an operation such as a swipe to move the second application icon to position in the first display region which causes the line dividing the first display region and the second display region into nonoverlapping regions to move to the stopping position of the operation.

In some embodiments, the system 300 further includes code 14 that is executable by processor 8 to further perform in response to determining that the first operation is the second predetermined operation, displaying, in a first display region, a second application interface of a second application corresponding to one of the one or more second application icons, and controlling the first application interface to be in a non-display state. In other words, the second application is selected by performing an operation on one of the one or more second application icons and is displayed in the first display region, and the first application is not displayed.

In some embodiments, the system 300 further includes code 14 that is executable by processor 8 to defining control first and second display regions associated with display 7 according to any of the steps described above with respect to methods 100, 100′ shown in FIGS. 1A, 1B, 1C, or other figures referred to therein.

FIG. 11 is a schematic block diagram of one embodiment of an apparatus 400 for controlling display regions of an electronic device, e.g., a mobile phone or other electronic device. In one embodiment, the apparatus 400 includes a control module 9, that controls a display of an electronic device to display a first application interface corresponding to a first application and a second interface e.g. shortcut interface that includes one or more second application icons.

In the embodiment, the apparatus 400 further includes a detection module 10. The detection module 10 is configured to detect and acquire a first operation performed for the second application icon. The apparatus 400 further includes a determination module 11, configured to determine whether the first operation satisfies a first predetermined condition, and when the first operation satisfies the first predetermined condition, determine, from the display, a first display region and a second display region that does not overlap the first display region. The apparatus 400 further includes a display module 12, configured to display, in the second display region, a second application interface of a second application corresponding to the second application icon, and display, in the first display region, an interface related to the first application interface.

In some embodiments, the determination module 11 specifically comprises:

a first determination submodule, configured to determine whether the first operation is a first predetermined operation.

In some embodiments, the determination module 11 further comprises:

a second determination submodule, configured to determine whether the first operation is a second predetermined operation; and

a first display submodule, configured to, when the first operation is the second predetermined operation, display, in a first region corresponding to the first application interface, the second application interface of the second application corresponding to the second application icon, and control the first application interface to be in a non-display state.

In some embodiments, the display module 12 comprises:

an adjusting module, configured to adjust the size of the first application interface and acquire an adjusted first application interface having a size less than or equal to that of the first display region, to adapt to the first display region;

a second display submodule, configured to display the adjusted first application interface in the first display region; or

a third display submodule, configured to display a portion of the first application interface in the first display region.

In some embodiments, the control module 9 specifically comprises:

a first control submodule, configured to control the display of the electronic device to display the first application interface in a first region, and display the second interface in a second region;

wherein the second display region comprises at least a first sub-region of the first region and a second sub-region of the second region, the first sub-region and the second sub-region being adjacent sub-regions.

In some embodiments, the first operation is a swipe operation from a display position of the second application icon to the first region, and the first sub-region is acquired by the following steps:

determining that an operation end point of the swipe operation is at a first position of the display;

when the first position is in the first region, determining a straight line that passes through the first position and is parallel to an intersection line between the first region and the second region, wherein the first region intersects, but does not overlap the second region; and

based on the straight line, partitioning, from the first region, the first sub-region adjacent to the second sub-region.

In some embodiments, the first predetermined operation is a swipe operation from a display position of the second application icon to the first region, and the second predetermined operation is a tap operation on the second interface with respect to the second application icon; or

the first predetermined operation is a tap operation on the second interface with respect to the second application icon, and the second predetermined operation is a swipe operation from a display position of the second application icon to the first region.

In some embodiments, the electronic device further comprises:

a detecting and acquiring module, configured to, when the first application interface is displayed on the display, detect and acquire a second operation performed on the display; and

a fourth display submodule, configured to, when the second operation is a third predetermined operation, simultaneously display the second interface and the first application interface on the display.

In some embodiments, the electronic device further comprises:

a determining module, configured to, based on a predetermined rule, determine, from the electronic device, at least one application comprising the second application; and

a fifth display submodule, configured to display an application icon corresponding to each of the at least one application in the second interface.

In some embodiments, the electronic device further comprises:

a second control submodule, configured to control the second interface to be in a non-display state.

The one or more technical solutions according to the embodiments of the present application at least achieve the following one or more technical effects:

In the technical solutions of the embodiments of the present application, the technical solution of controlling a display of an electronic device to display a first application interface corresponding to a first application and a second interface comprising at least a second application icon; detecting and acquiring a first operation performed for the second application icon; determining whether the first operation satisfies a first predetermined condition, and when the first operation satisfies the first predetermined condition, determining, from the display, a first display region and a second display region that does not overlap the first display region; and displaying, in the second display region, a second application interface of a second application corresponding to the second application icon, and displaying, in the first display region, an interface related to the first application interface is employed.

To be specific, in the present application, the display interface of the currently running first application displays a shortcut display interface; a second application switching operation is performed for a second application icon in the shortcut display interface; and when the operation satisfies a predetermined condition, a display region for displaying the first application interface and the second application interface corresponding to the second application icon may be re-determined in the display interface. This prevents the scenario in the related art where the second application interface may be only displayed in full screen when the second application switching operation is performed for the second application icon in the shortcut display interface. Therefore, the technical problem in existing systems that when the electronic device is in the application switching process, the application interface has a single display effect is effectively solved.

Various embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
detecting, on a display of an electronic device configured to display a first application interface corresponding to a first application and a shortcut interface comprising one or more second application icons, a first operation performed on one of the one or more second application icons;
determining whether the first operation satisfies a predetermined condition; and
defining a first display region and a second display region in response to determining that the first operation satisfies the predetermined condition.

2. The method of claim 1, further comprising determining which of the one or more second application icons to display in the shortcut interface based on a predetermined rule.

3. The method of claim 1, wherein determining whether the first operation satisfies a predetermined condition comprises determining whether the first operation is one of:
a first predetermined operation selected from the group consisting of taps, swipes, presses, and combinations thereof; and
a second predetermined operation selected from the group consisting of taps, swipes, presses, and combinations thereof.

4. The method of claim 3, wherein the first predetermined operation is a swipe operation from a display position of the second application icon to the first display region, and the second predetermined operation is a tap operation on the shortcut interface with respect to the second application icon.

5. The method of claim 3, wherein the first predetermined operation is a tap operation on the shortcut interface with respect to the second application icon, and the second predetermined operation is a swipe operation from a display position of the second application icon to the first display region.

6. The method of claim 3, further comprising:
defining the first display region and the second display region such that the second display region does not overlap the first display region, in response to determining that the first operation is the first predetermined operation.

7. The method of claim 6, further comprising:
displaying, in the first display region, an interface related to the first application interface; and
displaying, in the second display region, a second application interface of a second application corresponding to one of the one or more second application icons.

8. The method of claim 7, further comprising controlling the shortcut interface to be in a non-display state.

9. The method of claim 6, wherein displaying, in the first display region, an interface related to the first application interface comprises one of:
acquiring a resized first application interface that fits within the first display region and displaying the resized first application interface in the first display region; and
displaying a portion of the first application interface in the first display region.

10. The method of claim 9, wherein a first sub-region of the first display region is displaced by a resized second display region so as to define a resized first display region.

11. The method of claim 10, wherein a line defining an intersection of the resized first display region and the resized second display region is determined to be at an ending position of the first predetermined operation performed on one of the one or more second application icons.

12. The method of claim 2, further comprising:
detecting a second operation performed on the display when the first application interface is displayed on the display; and
simultaneously displaying the first application interface and the shortcut interface on the display in response to the second operation comprising a third predetermined operation selected from the group consisting of taps, swipes, presses, and combinations thereof.

13. The method of claim 3, further comprising:
in response to determining that the first operation is the second predetermined operation, displaying, in a first display region, a second application interface of a second application corresponding to one of the one or more second application icons; and
controlling the first application interface to be in a non-display state.

14. A system comprising:
a display;
a processor, wherein the processor is configured to display a first application interface corresponding to a first application and a shortcut interface comprising one or more second application icons; and
a memory storing code that is executable by the processor to perform:
detecting, on the display, a first operation performed on one of the one or more second application icons;
determining whether the first operation is one of
a first predetermined operation selected from the group consisting of taps, swipes, presses, and combinations thereof, and
a second predetermined operation selected from the group consisting of taps, swipes, presses, and combinations thereof; and
defining a first display region and a second display region based on the first operation.

15. The system of claim 14, wherein the code is executable by the processor to further perform determining which of the one or more second application icons to display in the shortcut interface, based on a predetermined rule.

16. The system of claim 15, wherein in response to determining that the first operation is a first predetermined operation the code is executable to further perform:
defining the second display region such that it does not overlap the first display region;
displaying, in the first display region, an interface related to the first application interface; and
displaying, in the second display region, a second application interface of a second application corresponding to one of the one or more second application icons.

17. The system of claim 16, wherein displaying, in the first display region, an interface related to the first application interface comprises one of:
acquiring a resized first application interface that fits within the first display region and displaying the resized first application interface in the first display region; and
displaying a portion of the first application interface in the first display region.

18. The system of claim 17, wherein the code is executable to further perform defining a resized first display region and a resized second display region in response the first operation, wherein a line defining an intersection of a resized first display region and a resized second display region is determined to be at an ending position in the first display region of the first predetermined operation performed on one of the one or more second application icons.

19. The system of claim 15, wherein the code is executable to further perform:
in response to determining that the first operation is the second predetermined operation, displaying, in a first display region, a second application interface of a second application corresponding to one of the one or more second application icons; and
controlling the first application interface to be in a non-display state.

20. An apparatus, comprising:
a control module configured to control a display of an electronic device to display a first application interface corresponding to a first application and a second interface comprising one or more second application icons;
a detection module configured to detect and acquire a first operation performed for one of the one or more the second application icons;
a determination module configured to determine whether the first operation satisfies a first predetermined condition, and when the first operation satisfies the first predetermined condition, determine, from the display, a first display region and a second display region that does not overlap the first display region; and
a display module configured to display, in the second display region, a second application interface of a second application corresponding to the second application icon, and display, in the first display region, an interface related to the first application interface.
